(19) United States
(12) Patent Application Publication
(10) Pub. No.: US 2008/0279068 A1
(43) Pub. Date: Nov. 13, 2008

(54) Method of inspecting disc information

(75) Inventor: Chun-Cheng Wang, Hsinchu (TW)

Correspondence Address: BACON & THOMAS, PLLC, 625 SLATERS LANE, FOURTH FLOOR, ALEXANDRIA, VA, 22314-1176, US

(73) Assignee: LITE-ON IT CORPORATION, Hsinchu (TW)

(21) Appl. No.: 12/219,088

(22) Filed: Jul. 16, 2008

Related U.S. Application Data
(63) Continuation of application No. 11/105,423, filed on Apr. 14, 2005.

(30) Foreign Application Priority Data
Apr. 30, 2004 (TW) 93112305

(51) Int. Cl. G11B 5/58

(52) U.S. Cl. 369/53.2

(57) ABSTRACT

A method of inspecting disc information stored on an optical disc, for applying in an optical drive of a computer system. The method of inspecting disc information comprises a. outputting a standard command, for reading the disc structure of the disc; b. determining whether the reading was successful, if not, step c is performed; if yes, step d is performed; c. outputting a force read command, for reading the disc structure; d. receiving the disc structure; and e. outputting the corresponding disc information according to the disc structure. The invention can inspect various disc information of the optical disc, and the user database can be manually updated and expanded according to a user's will, thereby increasing the convenience of inspecting optical discs.

This application claims the benefit of Taiwan application Serial No. 093112305 filed Apr. 30, 2004, the subject matter of which is incorporated herein by reference.

### BACKGROUND OF THE INVENTION

1. Field of the Invention

The invention relates in general to a method of inspecting disc information, and more particularly to a method of inspecting disc information stored on an optical disc for applying in an optical disc drive of a computer system.

2. Description of the Related Art

In the age of digital era, the demands in the amount of data a computer can process and the associated capacity of storage have continued to increase, despite efforts by hardware companies in incessantly launching new memory products high in quality, capacity, speed of revolution and stability. Regardless of how quickly the computer can process files, however, if important documents were not appropriately saved or backed up in time, disastrous results can occur, in which not only important documents can no longer be recovered, but also heavy prices have to be paid resulting from the losses in human resources, time and money. For that reason, hard drives with large memory capacity have emerged to avoid such situations from occurring. Since optical discs have the advantages of large storage capacity, small size, light weight, simple for storing, easy to carry, and long storage without degradation, it is becoming more common that optical discs are used in place of conventional hard drives for storing important information.

For CDRs, CDRWs or DVDs alike, the disc quality of optical discs is determined by the dye used on the recording layer and the disc quality control handled by disc manufacturers. Often in time, low quality discs tend to cause the stored data to be lost, or even to cause errors in reading. Thus, while users are unable to determine CD quality from physically inspecting the discs, since the discs are often nicely wrapped and packaged, the information relating to the disc manufacturer and other relevant data are available. That is, these information are already recorded during the manufacturing process, and are available on the discs for the user's inspection.

Referring to FIG. 1 (PRIOR ART), a flow diagram of conventional method of inspecting disc information is shown. First, in step 102, a standard command is generated for reading the disc structure of the optical disc. Then, in step 104, the reading is determined if successful. If so, then step 108 is performed, in which the disc structure of the optical disc is received, and the corresponding disc information is outputted, so that a user can obtain disc information of the optical disc. Yet, if the reading is not successful, then step 106 is performed, in which a message is displayed notifying of read failure.

Through inspecting the basic disc information within the optical disc, the user can learn about the manufacturer and other relevant information, thereby providing the user a reference as to distinguish genuine discs from pirated ones.

During the disc manufacturing process, the basic disc information are recorded on the optical disc, and all of the basic information can be read out by the optical disc drive when being put into the optical disc drive. However, even all of the basic disc information can be read, only parts of the basic disc information are really used based on the standard command as in step 102. It means that when the optical disc drive received the standard command from a host to read the disc structure of the optical disc, all of the basic disc information are read out by the optical disc drive but only parts of the basic disc information are decoded and returned to the host.

Moreover, the steps of the standard command include checking steps before decoding the basic disc information. For example, a format check step may need to be check first for DVD+RW. If the checking result finds that the disc is unformatted, the disc drive will feedback a failure to the host without decoding any basic disc information even they can be read by the disc drive.

Therefore, with the conventional method of inspecting disc information, once the standard command was unable to return the disc structure information to the host because of the condition limits, even though these discs did record manufacturer and other relevant information, the user will not be able to obtain such information.

### SUMMARY OF THE INVENTION

It is therefore an object of the invention to provide a method of inspecting disc information, allowing a user to inspect disc information, and further allowing the user to update and expand on the disc information.

The invention achieves the above-identified object by providing a method of inspecting disc information stored on an optical disc, for applying in an optical disc drive of a computer system. The method of inspecting disc information includes: a. outputting a standard command, for reading the disc structure of the disc; b. determining whether the reading was successful, if not, step c is performed; if yes, step d is performed; c. outputting a force read command, for reading the disc structure; d. receiving the disc structure; and e. outputting the corresponding disc information according to the disc structure.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 (PRIOR ART) shows a flow diagram of a conventional method of inspecting disc information.

FIG. 2A shows a flow diagram illustrating the method of inspecting the disc information according to a first embodiment of the invention.

FIG. 2B shows a flow diagram of step 210 of FIG. 2A.

FIG. 3A shows illustration of the disc structure of an optical disc.

FIG. 3B shows illustration of the disc structure in the database and the corresponding disc information.

FIG. 3C shows illustration of the disk information outputted corresponding to the disc structure of the optical disc.

FIG. 4A shows illustration of tracks on the optical disc.

FIG. 4B shows illustration of a wobble on the optical disc.

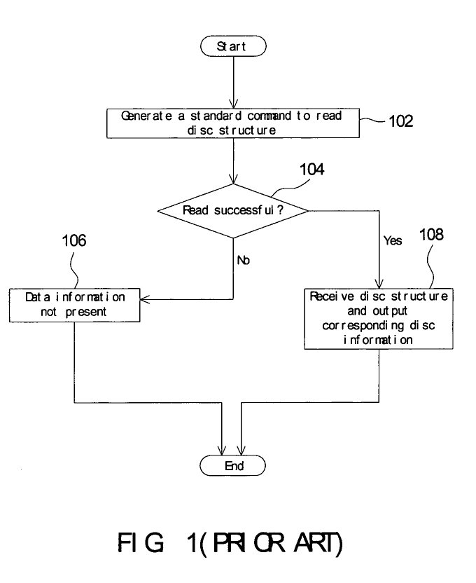

### DETAILED DESCRIPTION OF THE INVENTION

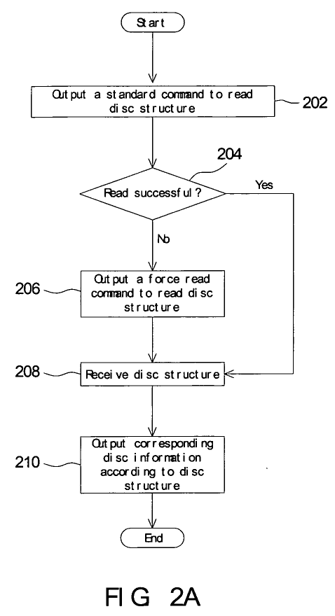

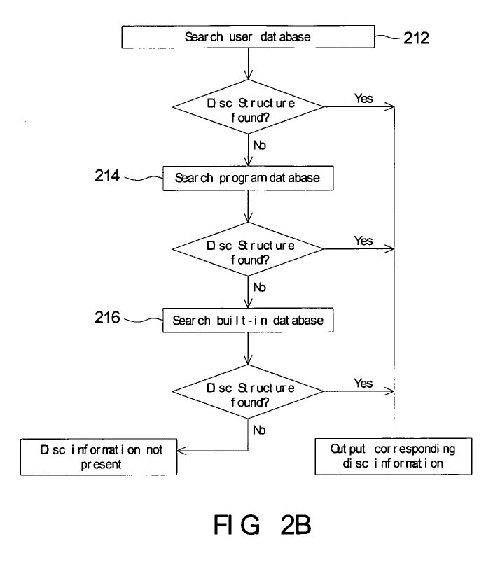

Referring to FIG. 2A, the flow diagram illustrating the method of inspecting the disc information according to a first embodiment of the invention is shown. First, in step 202, a standard command is outputted, for reading the disc structure of an optical disc. Then, in step 204, the reading is determined whether to be successful. If yes, then step 208 is performed. If not, then step 206 is performed. In step 206, a force read command is outputted, for reading the disc structure of the optical disc. In step 208, the disc structure of the optical disc is received. Lastly, in step 210, the corresponding disc information is outputted according to the disc structure.

The force read command can be set by disc drive manufacturers to directly decode the disc information without prior checking process. Therefore, even the disc is unformatted, the user still is able to obtain the disc information under the force read commend. The condition limits are ignored.

Moreover, the force read command also can be set to decode all of the disc information or another parts of the disc information different from the parts decoded under the standard comment. Or, the force read command can be set by containing both of the features above, ex. decoding all of the disc information without Prior checking process.

Preferably, step 210 includes numerous steps, as shown in FIG. 2B, where a flow diagram of step 210 of FIG. 2A is shown. First, in step 212, the same disc structure is being searched for in a user database, and if the search is successful, then the corresponding disc information is outputted according to the disc structure in the user database. The user database includes numerous information created by the user, including numerous disc structures and the corresponding disc information, that are to be used for matching the disc structures of different brands of optical discs.

If the disc structure of the optical disc is not found in the disc structures in the user database, however, then step 214 is performed. In step 214, the disc structure of the optical disc is searched for in the program database to determine if a same disc structure exists. If the search is successful, then the corresponding disc information is outputted according to the disc structure in the program database. The program database is embedded in the optical disc drive, and is being created by the manufacturer of the optical disc drive. The program database includes numerous disc structures and the corresponding disc information created by the manufacturer of the optical disc drive, to be used for matching the disc structures of different brands of optical discs.

If a search in the program database for a disc structure same as that of the optical disc is unsuccessful, then step 216 is performed. In step 216, a disc structure same as the disc structure of the optical disc is searched for in the built-in database. If the search is successful, then the corresponding disc information is outputted according to the disc structure in the built-in database. The built-in database is also embedded in the optical disk drive, and is being created by the OEM manufacturer for the optical disc drive manufacturer. The built-in database includes numerous disc structures and the corresponding disc information, to be used for matching the disc structures of different brands of optical discs.

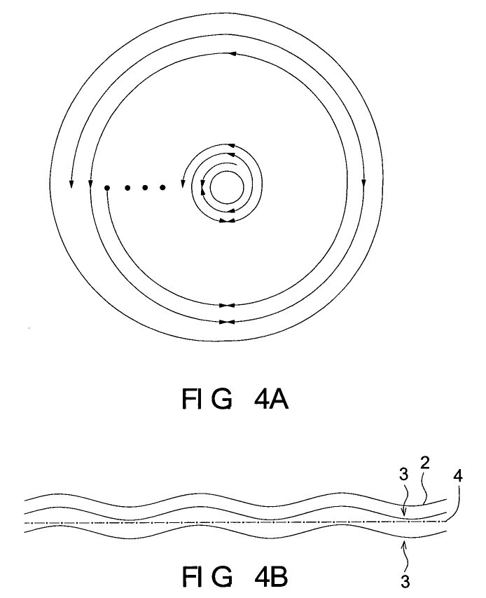

Generally speaking, during the manufacturing stage of optical discs, the tracks of the optical discs have the shapes of spiral grooves, as shown in FIG. 4A. And as shown in FIG. 4B, the tracks, such as a track 4, is often accompanied with a high frequency phase modulation signal 2, which has the shape of a sinusoid, called a wobble. In this embodiment, track 4 is a groove, and is disposed near land 3.

Taking a re-writable CD-RW disc as an example, the wobble signal includes a time-code information of the optical disc, referred to as the absolute time in pre-groove (ATIP). From decoding ATIP, information such as the disc format and the disc track allocation can be known. Thus, even when there is no data written on the optical disc, the optical disc drive can obtain relevant information regarding to the optical disk from ATIP.

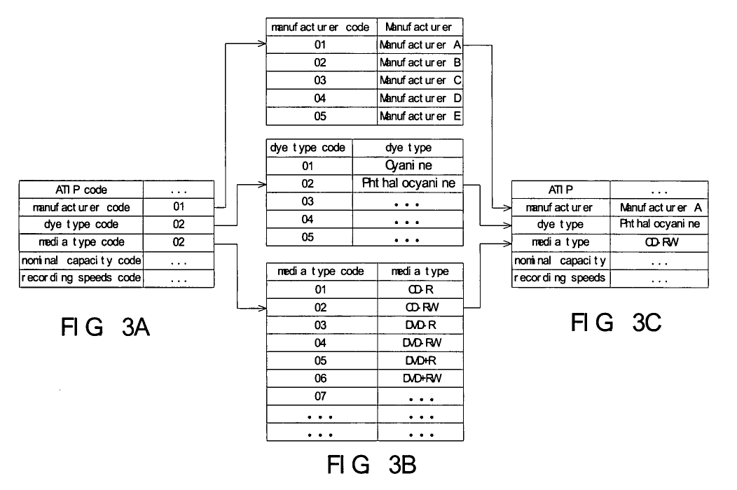

Please refer to FIGS. 3A, 3B and 3C. FIG. 3A shows illustration of the disc structure of an optical disc. FIG. 3B shows illustration of the disc structure in the database and the corresponding disc information. FIG. 3C shows illustration of the disk information outputted corresponding to the disc structure of the optical disc. The optical disc is used as a medium for storing large amount of information, and depending on the media type, the amount of information allowable for storage on the disc varies. For instance, optical discs include recordable optical discs CD-R, CD-RW, DVD-R, DVD-RW, DVD+R and DVD+RW etc. From the media type, the optical disc types can be determined. That is, dye type indicates the type of dye used on the recording layer, such as green, blue, and aquatic optical discs would indicate that the dye type Cyanine, whereas gold optical discs would indicate that the dye type is of a better light resistivity, Phthalocyanine.

The disc structure that can be obtained from ATIP include disc manufacturer, dye type, media type, nominal capacity, and recording speeds etc., such as shown in FIG. 3A.

To make convenient for illustration, in FIG. 3B, the disc structure and the corresponding disc information contained in the database are organized into three sets of disc structures and the corresponding disc information, having headings of “Disc Manufacturer Code” and “Disc Manufacturer”, “Dye Type Code” and “Dye Type”, and “Media Type Code” and “Media Type”. Each set of disc structure and the corresponding disc information is organized into data tables, and is used to match with the disc structure of the optical disc.

Regardless of being a user database, a program database or a built-in database, each of the databases is organized into data tables. Hence, while searching for disc structure in the user database, program database or built-in database, if a disc structure in any data table matches the disc structure of the optical disc, then the corresponding disc information can be outputted.

In FIG. 3A, the disc structure of the optical disc records the following: disc manufacturer code being 01; dye type code being 02; media type code being 02. Thus, if the data table in FIG. 3B has a disc structure that matches the disc structure of the optical disc, then the respective search for the three codes in the databases have been successful. Disc manufacturer code of 01 corresponds to disc manufacturer A; dye type code 02 corresponds to dye type of Phthalocyanine; media type code 02 corresponds to media type of CD-RW. Therefore, through the output data table, as shown in FIG. 3C, the user can obtain the disc information of the disc structure relating to the optical disc. That is, the user will be able to know that the disc is manufactured by disc manufacturer A, the dye type used is Phthalocyanine, and the media-type is CD-RW.

If, however, no disc structure in the built-in database matches the disc structure of the optical disc, in other words, the search for disc structure was unsuccessful because the disc information does not exist, then the user can choose to manually update the user database to include such information. Namely, by adding disc information corresponding to the disc structure of the optical disc at hand, then in the future, if there were an optical disc from the same manufacturer or of the same type, then the method of inspecting disc information according to the invention can be utilized. That is, the same disc structure to that of the optical disc can be searched for in the user database, and the corresponding disc information can be outputted according to the disc structure of the user database.

Thus, when confronted with a variety of optical discs, the user will no longer be unable to obtain the relevant disc information. Simply, by using the method of inspecting disc information according to the above-preferred embodiment, and through manually updating and expanding the user database, the user will be able to obtain disc information of every type of optical disc. Hence, the process of inspecting disc information of optical discs becomes less burdensome, without having to passively wait for the disc manufacturer or the OEM manufacturer to update and expand the program database or built-in database.

In addition, with respect to optical disc drives using IDE interface, the above-mentioned method of inspecting disc information of the optical disc further integrates the standard ATAPI command, for applying in the optical disc drive of a computer system to display optical disc drive model number, firmware version, and drive type etc. Also, by utilizing a force read command to forcefully read an unformatted DVD disc, such as a DVD+RW disc, the conventional problem arising from unable to read the disc structure of unformatted DVDs can be solved.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method of inspecting disc information stored on an optical disc, for applying in an optical disc drive of a computer system, the method comprising:
a. outputting a standard command, for reading the disc structure of the optical disc, wherein the standard commend includes a prior checking step;
b. determining if the reading is successful, if not, performing step c; if so, performing step d;
c. outputting a force read command, for forcefully reading the disc structure of the optical disc, wherein the force read command is set for decoding the disc information without the prior checking step;
d. receiving the disc structure of the optical disc; and
e. outputting correspondingly the disc information according to the disc structure of the optical disc.

2. The method according to claim 1, wherein the disc structure is being searched for in a user database during step e, and the corresponding disc information is outputted if the search in the user database is successful.

3. The method according to claim 2, wherein the user database is being created by a user.

4. The method according to claim 2, wherein the disc structure is being searched for in a program database if the disc structure search in the user database is unsuccessful during step e, and the corresponding disc information is outputted if the search in the program database is successful.

5. The method according to claim 2, wherein the program database is embedded in the optical disc drive.

6. The method according to claim 4, wherein the disc structure is being searched for in a built-in database if the disc structure search in the program database is unsuccessful during step e, and the corresponding disc information is outputted if the search in the built-in database is successful.

7. The method according to claim 6, wherein the built-in database is embedded in the optical disc drive.

8. The method according to claim 1, wherein the disc structure comprises at least one of a disc manufacture code, a dye type code, a media type code, a nominal capacity code, and a recording speed code.

9. The method according to claim 8, wherein the disc information corresponds to the disc structure, the disc information comprising at least one of a disc manufacture name, a dye type, a media type, a nominal capacity, and a recording speed.

10. The method according to claim 1, wherein the optical disc is a CD-R or a CD-RW recordable optical disc.

11. The method according to claim 1, wherein the optical disc is a DVD-R or a DVD-RW recordable optical disc.

12. The method according to claim 1, wherein the optical disc is a DVD+R or a DVD+RW recordable optical disc.
